(19) United States
(12) Patent Application Publication
(10) Pub. No.: US 2022/0235938 A1
(43) Pub. Date: Jul. 28, 2022

(54) Campfire Mat

(71) Applicants: David Novak, Menomonee Falls, WI (US); Alisa Novak, Menomonee Falls, WI (US)

(72) Inventors: David Novak, Menomonee Falls, WI (US); Alisa Novak, Menomonee Falls, WI (US)

(21) Appl. No.: 17/324,279

(22) Filed: May 19, 2021

Related U.S. Application Data
(60) Provisional application No. 63/142,928, filed on Jan. 28, 2021.

(51) Int. Cl. F24B 1/191; A47J 37/07

(52) U.S. Cl. CPC F24B 1/191; A47J 37/0763

(57) ABSTRACT

This present invention relates to a campfire or firepit mat designed for outdoor use around a campfire/fire pit. The mat has a continuous circular opening in the center of its area to allow for placement around the campfire or firepit. The mat is made up of durable weave material that is water-resistant, flame-resistant, mildew-resistant, rugged, flexible and scratch free. The mat prevents dirt, sand, mud, water and snow from accumulating along the top surface of the mat and soiling the clothing and shoes of individuals utilizing the mat. The mat may also have an LED light system, a battery and a wireless communication module that can pair with a mobile application on an electronic device to control the operation of the LED light system.

### CROSS-REFERENCE TO RELATED APPLICATION

The present application claims priority to, and the benefit of, U.S. Provisional Application No. 63/142,928, which was filed on Jan. 28, 2021 and is incorporated herein by reference in its entirety.

### FIELD OF THE INVENTION

The present invention relates generally to the field of mats. More specifically, the present invention relates to a campfire mat designed for use around an outdoor campfire or fire pit. The campfire mat is comprised of an area of fabric having a general circular opening in the center thereof to allow for placement around a campfire or fire pit. The uniquely designed campfire mat offers a clean, dry and comfortable place for the users to sit while enjoying an outdoor fire. The mat is made up of a durable weave material that is water, flame and mildew resistant, and that dries quickly. Additionally, the campfire mat allows water to pass through the mat surface to avoid a wet top surface and to prevent dirt, sand, mud and snow from soiling the clothing and shoes of its users. In a preferred embodiment, the campfire mat may further comprise a lighting component. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, a campfire is one of the most common activities enjoyed by individuals on picnics and at campsites, and is widely considered to be the heart of a campsite. A campfire is a fire built outdoors that provides light and warmth, and heat for cooking. The campfire may also serve as a beacon, and an insect and predator deterrent. Creating a campfire is typically one of the most important parts of any camping trip, as it attracts people to warm their hands, cook food for the camping trip, roast s'mores, sing songs, share stories, and in general serves to gather individuals close together.

Typically, to build a campfire, a plurality of wooded sticks or other kindling is arranged over a circular base on the ground in a cone-shaped structure, and lit with a match or other fire starting instrument. Once the campfire has been started, individuals typically sit around the campfire in a circular arrangement to stay warm, cook and enjoy each other's company. However, when attending a campfire outside, such as at a fire pit, it is oftentimes difficult to enjoy the campfire without becoming wet, muddy or otherwise dirty, particularly if it has rained recently. Additionally, due to an uneven ground surface around the campfire, many children, adults and even pets are often unable to find a comfortable place to sit or place a chair. Individuals experiencing discomfort around the campfire may not be able to enjoy the campfire and/or the campout. Others may need to frequently change positioning to become comfortable, or may simply leave the campfire early.

As noted above, while sitting, standing or lying on the ground around the campfire, an individual's clothes and footwear may easily become dirty or soiled due to the presence of dirt, mud and other debris on the ground surface around the campfire. Further, individuals sitting, standing or lying around the campfire may oftentimes track said dirt, mud and other debris back into a tent, camper, vehicle and/or home via their clothing and footwear, which places additional burdens on those that must then clean said clothes, the tent, camper, vehicle and/or home.

Therefore, there exists a long felt need in the art for a campfire mat that enables individuals to sit comfortably beside a campfire at a campsite, picnic, etc., and that is capable of encircling the campfire. Moreover, there is a long felt need in the art for a campfire mat that prevents individuals who are sitting, standing or laying near a campfire from becoming dirty, wet or muddy, and therefore prevents said individuals from then tracking the dirt or mud to a tent, camper, vehicle and/or home. There is also a long felt need in the art for a campfire mat that is water, flame and mildew resistant and easy to clean, and that allows water to pass therethrough, thereby eliminating water from pooling on the top surface of the campfire mat. Finally, there is a long felt need in the art for a campfire mat that is relatively inexpensive to manufacture, and that is both safe and easy to use.

The subject matter disclosed and claimed herein, in one embodiment thereof, is a flame-resistant campfire mat designed for use around a campfire or firepit and that comprises a single unit mat having a circular central opening that is dimensioned to be placed around a campfire or firepit, a top surface for people to sit on, a bottom surface on which the mat is placed on a ground, and, in a preferred embodiment, a plurality of waterproof LED lights sewn or woven into the top surface along the circumferential edge or perimeter of the mat. The campfire or firepit mat is water-resistant, flame-resistant, mildew-resistant, flexible and dries relatively quickly. The campfire mat also allows water to pass through it to minimize sand, dirt and other debris from accumulating on the top surface, and therefore prevents dirt, sand, mud and snow from soiling clothing and footwear of the individuals sitting, standing or laying on the mat.

In this manner, the novel campfire mat of the present invention accomplishes all of the forgoing objectives, and provides a relatively safe, easy and convenient solution to allowing users to be positioned around a campfire at a campsite, picnic or the like. The campfire mat of the present invention is also user friendly, as it allows individuals to sit, stand or lay comfortably beside the campfire, and prevents the individuals from getting their clothing and footwear dirty due to the dirt, mud or other debris present around the campfires. The campfire mat offers a clean, dry, comfortable place to sit, stand or lay while enjoying an outdoor fire.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flame-resistant mat designed for use around a campfire or firepit. The campfire mat comprises an area of material having a circular and centralized opening that is dimensioned to place around a campfire or firepit, a top surface for people to sit, stand or lay on, and a bottom surface that is in contact with the ground. In a further embodiment, a waterproof LED light system can be attached to the top surface of the campfire mat along its perimeter. The campfire or firepit mat is water-resistant, flame-resistant, mildew-resistant, flexible, washable and dries quickly. The campfire mat also allows water to pass from the top surface through the bottom surface, thereby preventing water, such as rainwater, from accumulating on the top surface of the mat.

In a further embodiment of the present invention, a fire-resistant mat for outdoor use around a campfire or firepit is disclosed. More specifically, the campfire mat is geometrically shaped and is comprised of a top surface, an opposing bottom surface and a central circular opening that extends from the top surface to the bottom surface, wherein the mat is placed on a ground surface so that a campfire or firepit is positioned within the central circular opening. The novel campfire mat is further comprised of a fire resistant and/or retardant material, or may have a fire-resistant coating on its top surface such as, but not limited to an aluminum trihydrate. For example, in one embodiment of the present invention, the material may comprise up to 40 percent by weight of an aluminum trihydrate, melamine, sodium tetraborate decahydrate or combinations thereof to achieving the desired flame/fire resistance.

The campfire or firepit mat of the present invention offers individuals a clean, dry and comfortable place to sit, stand or lay near a campfire. In doing so, the campfire mat also prevents dirt, sand, mud, water and snow from soiling the individual's clothing and/or footwear while enjoying the campfire mat. The campfire mat can be of any shape, color, size or design that suits user preference and may also comprise one or more rust-resistant grommets positioned near the outer edge or perimeter of the mat for securing the campfire mat to the ground using screws or any other suitable fastening mechanism.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the campfire mat of the present invention in a fully deployed position and in accordance with the disclosed architecture;

FIG. 2 illustrates a cross-sectional view of one potential embodiment of the campfire mat of the present invention in accordance with the disclosed architecture;

FIG. 3 illustrates a perspective view of one potential embodiment of the campfire mat of the present invention in accordance with the disclosed architecture, wherein a campfire is positioned within the centralized opening;

FIG. 4 illustrates a perspective view of one potential embodiment of the campfire mat of the present invention in accordance with the disclosed architecture, wherein a campfire is positioned within the centralized opening and a plurality of individuals are positioned on the top surface of the campfire mat and enjoying the campfire;

FIG. 5 illustrates a perspective view of one potential embodiment of the campfire mat of the present invention in accordance with the disclosed architecture, wherein the campfire mat is being folded for easy transportation and storage;

FIG. 6 illustrates a top perspective view of another potential embodiment of the campfire mat of the present invention in a fully deployed position and in accordance with the disclosed architecture; and

FIG. 7 illustrates a perspective view of one potential embodiment of the campfire mat of the present invention in a fully deployed position in accordance with the disclosed architecture, wherein the campfire mat further comprises an LED lighting system.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a campfire mat that enables individuals to sit comfortably beside a campfire at a campsite, picnic, etc., and that is capable of encircling the campfire. Moreover, there is a long felt need in the art for a campfire mat that prevents individuals who are sitting, standing or laying near a campfire from becoming dirty, wet or muddy, and therefore prevents said individuals from then tracking the dirt or mud into a tent, camper, vehicle and/or home. There is also a long felt need in the art for a campfire mat that is water, flame and mildew resistant and easy to clean, and that allows water to pass therethrough, thereby eliminating water from pooling on the top surface of the campfire mat. Furthermore, there is a long felt need in the art for a campfire mat that is comprised of a waterproof LED light system, a speaker, a battery and a wireless communication module that can be paired with a mobile application to control the operation of the LED lighting system and/or speaker with a remote electronic device to provide additional ambiance to the campfire setting. Finally, there is a long felt need in the art for a campfire mat that is relatively inexpensive to manufacture, and that is both safe and easy to use.

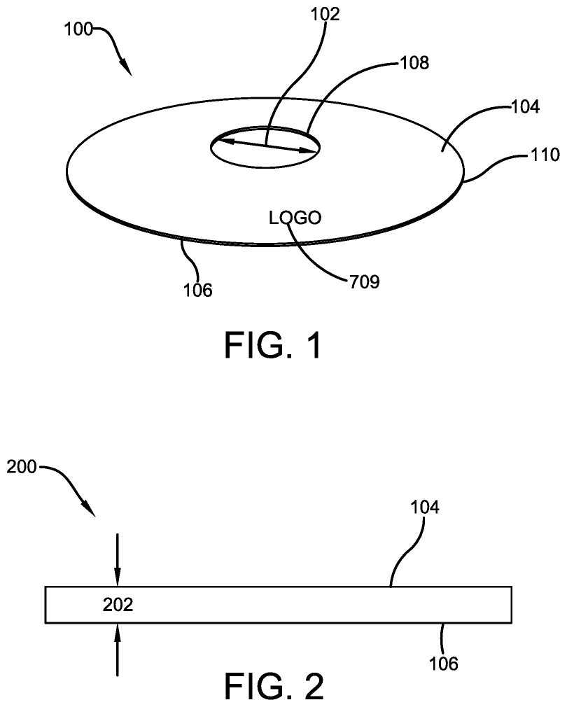

Referring initially to the drawings, FIG. 1 illustrates a perspective view of one potential embodiment of the campfire mat 100 of the present invention in a fully deployed position and in accordance with the disclosed architecture. The campfire mat 100 is specifically designed for outdoor use around a campfire or fire pit and in all types of weather and settings. The campfire mat 100 has a central circular opening 102 of an appropriate diameter to allow for placement around a campfire or a fire pit. The circular opening 102 has a diameter in the range 30″-72″ to accommodate various firepits and campfires of different diameters. When placed around a campfire or firepit, a healthy margin or gap exists between the exterior surface of the firepit or campfire and the circular boundary 108 of the central circular opening 102.

The campfire mat 100 is also comprised of a top surface 104 and an opposing bottom surface 106. The top surface 104 offers a clean, dry and comfortable place for individuals to sit, stand or lay while enjoying an outdoor fire, and the bottom surface 106 is meant for contacting the ground. The campfire mat 100 is preferably comprised of an integral unit with no modular or detachable components, and is made up of a durable weave material that is water-resistant, flame-resistant, mildew-resistant, and that dries quickly when the same becomes wet. Nonetheless, the invention is not so limited and the campfire mat 100 may also be comprised of two or more modular or attachable components. In one embodiment, the top surface 104 can be used as the bottom surface 106 and similarly, the bottom surface 106 can be used as the top surface 104.

The campfire mat 100 of the present embodiment has a circular shape where the circumferential periphery 110 is concentric to the circular boundary 108 of the circular opening 102. However, the campfire mat 100 of the present invention is not so limited and the campfire mat may be of any shape, size or configuration that satisfied user need and/or preference.

FIG. 2 illustrates a cross-sectional view of one potential embodiment of the campfire mat 100 of the present invention in accordance with the disclosed architecture. More specifically, the sectional view 200 shows both the top and bottom surfaces 104, 106 of the campfire mat 100, wherein the mat 100 comprises a sectional thickness 202. Due to the sectional thickness 202 and material of the mat 100, water is allowed to pass through the mat while minimizing sand, dirt and debris. In spite of its relative thickness, the campfire mat 100 is foldable for easy transportation and storage. In one embodiment, the thickness 202 may be between 0.125″ and 1″, for example.

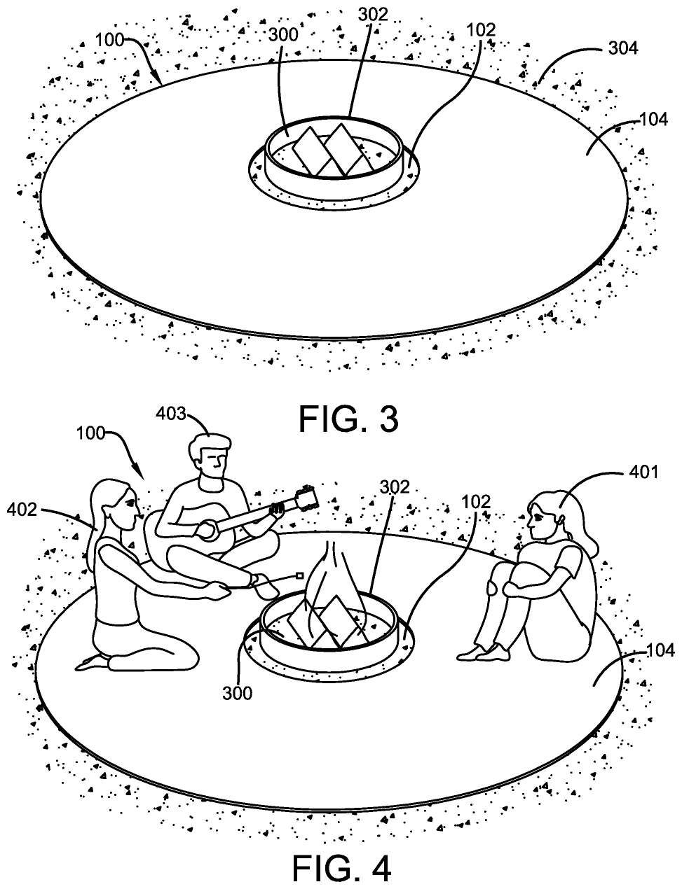

FIG. 3 illustrates a perspective view of one potential embodiment of the campfire mat 100 of the present invention in accordance with the disclosed architecture, wherein a campfire/fire pit 300 is positioned within the centralized opening. As shown, the firepit 300 is placed on the ground 304 and has a periphery 302. The central circular opening 102 surrounds the firepit periphery 302 while a safety margin or gap is maintained between the circular boundary 108 and the periphery 302. The top surface 104 of the mat is available for users to sit, stand or lay on while enjoying the firepit or campfire 300. Further, the top surface 104 of the mat prevents dirt, sand, mud, water and snow from accumulating thereon and soiling the clothing and/or shoes of the user.

FIG. 4 illustrates a perspective view of one potential embodiment of the campfire mat 100 of the present invention in accordance with the disclosed architecture, wherein a campfire 300 is positioned within the centralized opening 102, and a plurality of individuals are positioned on the top surface 104 of the campfire mat 100 and enjoying the campfire. More specifically, the campfire mat 100 provides a safe and relatively clean top surface 104 upon which a plurality of users, such as a first user 401, a second user 402 and a third user 403, may sit, stand or lay upon as they enjoy the campfire. Additionally, the fire 300 remains at the center of the central circular opening 102, thereby ensuring that the users 401, 402, 403 maintain a safe distance from the firepit 300.

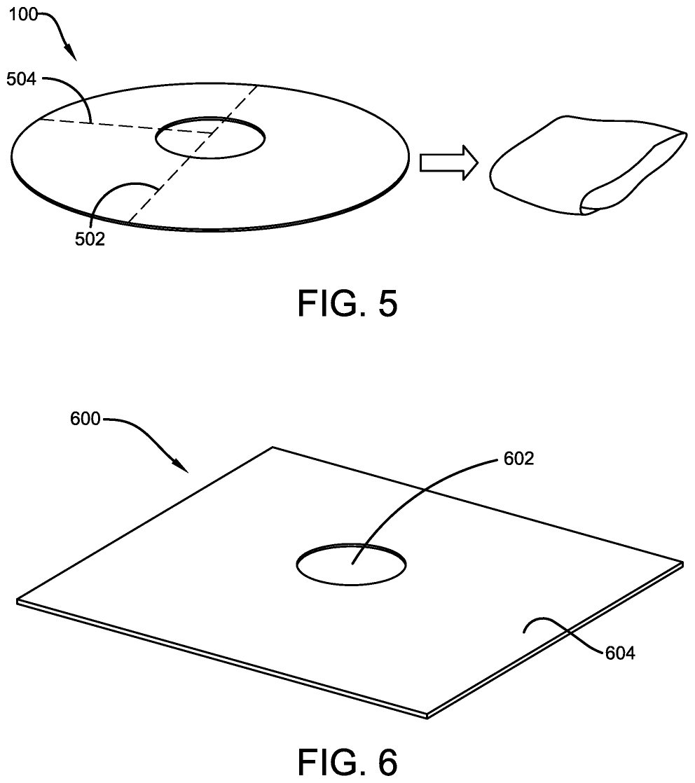

FIG. 5 illustrates a perspective view of one potential embodiment of the campfire mat 100 of the present invention in accordance with the disclosed architecture, wherein the campfire mat 100 is being folded for easy transportation and storage. More specifically, the campfire mat 100 is easily rolled or foldable into a compact size for easy transportation and storage. In a circular embodiment of the camping mat 100, the mat may be folded along one of the diameters, such as diameter 502, and then folded a second time along any other diameter, such as a second diameter 504 to form a quarter circle. In this manner, the folded mat 100 is very compact and relatively easy to carry. A carry bag with a zipper or other closing mechanism may also be made available with the mat 100 to securely transport and store the mat 100.

FIG. 6 illustrates a top perspective view of another potential embodiment of the campfire mat 600 of the present invention in a fully-deployed position in accordance with the disclosed architecture. As shown, the campfire mat 600 of the present invention is rectangular or square 604 with a circular central opening 602. The central circular opening 602 surrounds the firepit and the top surface 604 may be used by individuals, such as users 401, 402, 403, to sit, stand or lay upon as they enjoy the campfire 300.

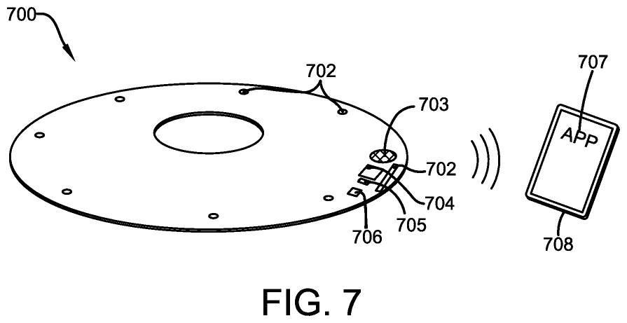

FIG. 7 illustrates a perspective view of one potential embodiment of the campfire mat 700 of the present invention in a fully-deployed position in accordance with the disclosed architecture, wherein the campfire mat 700 further comprises an LED lighting and sound system. More specifically, the campfire mat 700 of the present embodiment comprises a LED strip or plurality of lights 702 that may be positioned along the circumferential edge of the mat 700, and at least one speaker 703. Nonetheless, the invention is not so limited and the LED strip or plurality of lights 702 that may be positioned elsewhere along the matt 700 such as, but not limited to along the central opening, etc.

Each of the LED strip 702 and the speaker 703 is preferably waterproof and suitable for an outside environment. A push switch 704 is also present near the circumferent edge to control the LED lights 702 and/or speaker 703. The LED lights 702 and the speaker 703 may be powered by one or more disposable or rechargeable batteries 705 and increase the aesthetic appeal of the campfire mat 100.

In a further embodiment of the present invention, the campfire mat 100 of the present invention may further comprise an RFID tag, GPS transmitter or other wireless communication module 706 embedded in the mat 100 or positioned along its top or bottom surfaces 104, 106 that may be wirelessly paired with a mobile application 707 on a remote electronic device 708, as best shown in FIG. 7. The RFID tag, GPS transmitter or other wireless communication module 706 may be powered by the battery 705 and can be used by the owner to control the plurality of LED lights 702 and/or the speaker 703 remotely to, for example, change a song being played, change the color of the LED lights 702 or their mode of operation (i.e., continuous, blinking, strobe, etc.). The remote electronic device 708 may be, but it not limited to, a smartphone, smart watch, computer, tablet or the like.

The campfire mat 100 in each of the embodiments described herein can be used while camping, picnicking, playing in a park, hiking, backpacking, hunting, fishing or just resting. The campfire or firepit mat 100 may come in a plurality of colors, shapes, dimensions and designs, and may also comprise a logo 709, trademark, design or embroidery on the top and/or bottom surfaces 104, 106 of the campfire or firepit mat 100. The mat 100 may also have a waterproof PEVA backing in order to keep out moisture, for comfortable seating and to provide for relatively easy clean-up. The mat 100 of the present invention is rugged, durable and holds up to repeated use and stress. Further, the mat 100 does not get easily scratched or ripped when placed over an irregular surface.

In one embodiment, the mat 100 is machine washable and dryer safe after its electronic components have been removed therefrom. The material of the mat 100 may be breathable, water-resistant, flame-resistant, mildew-resistant, and may dry relatively quickly when wet. The mat of all the embodiments may have a fire-resistant coating on both the top surface and the bottom surface, as described herein.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “campfire or firepit mat”, “campfire mat”, “firepit mat”, and “mat” are interchangeable and refer to the campfire or firepit mat 100 of the present invention.

Notwithstanding the forgoing, the campfire or firepit mat 100 of the present invention can be of any suitable size and configuration as is known in the art without affecting the overall concept of the invention, provided that it accomplishes the above stated objectives. One of ordinary skill in the art will appreciate that the size, configuration and material of the campfire or firepit mat 100 as shown in the FIGS. are for illustrative purposes only, and that many other sizes and shapes of the campfire or firepit mat 100 are well within the scope of the present disclosure. Although the dimensions of the campfire or firepit mat 100 are important design parameters for user convenience, the campfire or firepit mat 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A campfire mat for positioning around a campfire, the campfire mat comprising:
a mat material comprised of a top surface, a bottom surface and a perimeter; and
a continuous opening in the mat material for receipt of the campfire.

2. The campfire mat as recited in claim 1, wherein the mat material is comprised of a flame resistant material or a flame resistant coating.

3. The campfire mat as recited in claim 2, wherein the flame resistant coating is comprised of an aluminum trihydrate.

4. The campfire mat as recited in claim 2, wherein the flame resistant material is comprised of an aluminum trihydrate, a melamine, a sodium tetraborate decahydrate or a combinations thereof.

5. The campfire mat as recited in claim 3, wherein the flame resistant material comprises up to 40 percent by weight of a weight of the campfire mat.

6. The campfire mat as recited in claim 5, wherein the mat material is comprised of a mildew resistant material.

7. The campfire mat as recited in claim 6, wherein the mat material is comprised of a water-resistant material.

8. The campfire mat as recited in claim 6, wherein the mat material permits water to pass therethrough from the top surface to the bottom surface.

9. The campfire mat as recited in claim 8 further comprising an LED light system.

10. The campfire mat as recited in claim 9, wherein the LED light system comprises a rechargeable battery and a plurality of LED lights in electrical communication with the rechargeable battery.

11. The campfire mat as recited in claim 10, wherein the plurality of LED lights are positioned along the top surface and perimeter of the mat material.

12. A campfire mat for positioning around a campfire, the campfire mat comprising:
a mat material comprised of a top surface, a bottom surface and a perimeter;
a continuous opening in the mat material for receipt of the campfire;
an LED light system; and
a wireless communication module.

13. The campfire mat as recited in claim 12, wherein the mat material is comprised of a flame resistant material or a flame resistant coating.

14. The campfire mat as recited in claim 13, wherein the flame resistant coating is comprised of an aluminum trihydrate.

15. The campfire mat as recited in claim 13, wherein the flame resistant material is comprised of an aluminum trihydrate, a melamine, a sodium tetraborate decahydrate or a combinations thereof.

16. The campfire mat as recited in claim 13, wherein the flame resistant material comprises up to 40 percent by weight of a weight of the campfire mat.

17. The campfire mat as recited in claim 16, wherein the mat material is comprised of a mildew resistant material.

18. The campfire mat as recited in claim 17, wherein the mat material is comprised of a water-resistant material.

19. A campfire mat system comprising:
a mat material comprised of a top surface, a bottom surface and a perimeter;
a continuous opening in the mat material for receipt of a campfire;
an LED light system comprising a plurality of LED lights and a battery, wherein the plurality of LED lights is positioned along the perimeter of the mat material;
a speaker;
a wireless communication module; and
a mobile application installed on an electronic device, wherein the mobile application is wirelessly paired with the wireless communication module to control an operation of the LED light system.

20. The campfire mat as recited in claim 19, wherein the mobile application is used to change a color and a mode of operation of the plurality of LED lights.
